(19) United States
(12) Patent Application Publication
(10) Pub. No.: US 2005/0223076 A1
(43) Pub. Date: Oct. 6, 2005

(54) Cooperative spam control

(75) Inventors: William G. Barrus, Cary, NC (US); Cary L. Bates, Rochester, MN (US); Robert J. Crenshaw, Cary, NC (US); Paul Reuben Day, Rochester, MN (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 10/816,602

(22) Filed: Apr. 2, 2004

(51) Int. Cl. G06F 15/16

(52) U.S. Cl. 709/207

(57) ABSTRACT

A method, system and apparatus for cooperative spam control. A cooperative spam control method can include the step of accepting an electronic spam notification received from a peer e-mail recipient in a common computing group identifying a spam message received by the peer e-mail recipient. The method further can include the step of storing the notification. Finally, if an e-mail is subsequently received which corresponds to the identified spam message, the received e-mail can be processed as spam. In a preferred aspect of the invention, the method also can include the steps of determining that a received e-mail is spam; and, communicating an electronic spam notification identifying the received e-mail determined to be spam to other peer e-mail recipients in the common computing group.

### BACKGROUND OF THE INVENTION

1. Statement of the Technical Field

The present invention relates to the field of managing the transmission and receipt of unsolicited commercial messages and more particularly to spam filtering and control.

2. Description of the Related Art

Second only to the telephone, electronic mail has become a principal mode of commercial communications. At present, more than 700 million electronic mailboxes have been activated worldwide and more than 30 billion electronic mail messages are transmitted on any given day. Consequently, it should be no surprise that the direct marketing industry has incorporated the electronic mail message as a means for mass broadcasting marketing messages in the same way the direct marketing industry has embraced the telephone and facsimile as a mode of direct advertising.

Historically, the print medium served as the principal mode of unsolicited mass advertising on the part of the direct marketing industry. Typically referred to as “junk mail”, unsolicited print marketing materials could be delivered in bulk to a vast selection of recipients, regardless of whether the recipients requested the marketing materials. With an average response rate of one to two percent, junk mail has been an effective tool in the generation of new sales leads. Nevertheless, recipients of junk mail generally find the practice to be annoying. Additionally, postage for sending junk mail can be expensive for significant “mail drops”. Consequently, the direct marketing industry constantly seeks equally effective, but less expensive modalities for delivering unsolicited marketing materials.

The advent of electronic mail has provided much needed relief for direct marketers as the delivery of electronic mail to a vast number of targeted recipients requires no postage. Moreover, the delivery of unsolicited electronic mail can be an instantaneous exercise and the unsolicited electronic mail can include embedded hyperlinks to product or service information thus facilitating an enhanced response rate for the “mail drop”. Still, as is the case in the realm of print media, unsolicited commercial electronic mail, referred to commonly as “spam”, remains an annoyance to consumers worldwide.

Spam has become problematic for all types of organizations, particularly Internet service providers (ISPs), mobile operators and corporate organizations. The cost of spam to United States corporate organizations in 2003 has been suggested to have surpassed the $10 billion mark. Presently, it is estimated that North American business users receive approximately ten spam messages per day, and ISP users approximately twelve spam messages per day. By 2008 it is estimated that business users will experience an increase of thirty spam messages to a total of forty spam messages per day while ISP users are expected to receive a total of fifty-four spam messages per day. As a result, an entire cottage industry of “spam filters” has arisen whose task solely is the eradication of spam.

Spam filters have come to exist in several forms. User defined spam filters allow the user to forward email to different mailboxes depending upon the nature of e-mail headers or the contents of an e-mail. Header filters are known to be more sophisticated in that header filters inspect the headers of e-mail to determine if the header has been forged. Notably, a forged header often indicates spam. Language filters simply filter out any e-mail having content composed in a language other than that of the recipient. Content filters scan the text of an e-mail and, through the use of fuzzy logic, provide a weighted opinion as to whether the e-mail is spam. Content filters can be highly effective, but occasionally content filters can inadvertently filter out newsletters and other bulk e-mail that may only appear to be spam. Finally, permission filters block all e-mail not originating from an authorized source.

Spam filters have proven to be moderately effective in screening much spam. Still, combating spam on a user-by-user basis has proven to be futile in its attempt to completely eradicate spam. In fact, so much of spam filtering depends upon the acquired knowledge of confirmed spam. That is to say, an end user can only be so effective in detecting spam depending upon the end user's previous experience in identifying spam, either on a content or spam source basis. Ironically, the more spam an end user has been able to detect, the more likely it is that the end user will be able to detect future spam of similar content. Conversely, the less spam an end user has been able to detect, the less likely the end user will be able to detect future spam. In any case, theoretically, the cumulative spam knowledge of all e-mail users globally ought to form the foundation of an optimal spam filter. Notwithstanding, to date spam filtering largely has been an exercise in individual effort.

Recently, cooperative efforts have been set forth to streamline the process of detecting and eliminating spam. Composite Blocking Lists and the Blacklist Domain Name Server (DNS) represent one such effort. In the Blacklist DNS effort, a central data store of known sources of spam can be collected and distributed to the central e-mail servers of subscribers. Upon an attempt by a spammer to transmit an e-mail message through the e-mail server, the e-mail server can identify the spammer by way of the central data store and can reject the receipt of the e-mail message. Nevertheless, Blacklist DNS involves substantial network integration and interoperability which largely ignores the spam knowledge of the subscribers. Rather, the administrator of the Blacklist DNS bears the burden of collecting and maintaining spam knowledge for the subscribers.

### SUMMARY OF THE INVENTION

The present invention addresses the deficiencies of the art in respect to spam management and control and provides a novel and non-obvious method, system and apparatus for cooperative spam control. A cooperative spam processing system can include two or more e-mail clients communicatively linked to one another. The system further can include two or more cooperative spam control processors. Each of the processors can be coupled to a corresponding one of the e-mail clients. Notably, the cooperative spam control processors can include programming for detecting spam and for notifying others of the cooperative spam control processors of the spam.

The system of the present invention also can include two or more peer policies, each coupled to a corresponding one of the spam control processors. Alternatively, the system can include a centrally managed peer policy coupled to a mail server associated with each of the e-mail clients and communicatively linked to the spam control processors. Notably, a group administrator can be included for the e-mail clients. The group administrator can have authority to establish an agreement to exchange spam notifications with other groups of e-mail clients having respective cooperative spam control processors.

A cooperative spam control method can include the step of accepting an electronic spam notification received from a peer e-mail recipient in a common computing group identifying a spam message received by the peer e-mail recipient. The method further can include the step of storing the notification. Finally, if an e-mail is subsequently received which corresponds to the identified spam message, the received e-mail can be processed as spam. In a preferred aspect of the invention, the method also can include the steps of determining that a received e-mail is spam; and, communicating an electronic spam notification identifying the received e-mail determined to be spam to other peer e-mail recipients in the common computing group.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a system, method and apparatus for cooperative spam processing in accordance with the inventive arrangements;

FIG. 2 is a flow chart illustrating a method for cooperative spam processing in the system of FIG. 1;

FIG. 3 is a block diagram depicting a client-side implementation of the method of FIG. 2;

FIG. 4 is a block diagram depicting a server-side implementation of the method of FIG. 2; and,

FIG. 5 is a pictorial illustration of a system and method for inter-group cooperative spam processing in accordance with a particular embodiment of the present invention.

### DETAILED DESCRIPTION OF THE PREFERRED EMBODIMENTS

The present invention is a method, system and apparatus for cooperative spam processing. In accordance with the present invention, members of a computing group can cooperate in sharing the identification of received e-mail as spam. Specifically, as individual members in the computing group identify spam, the individual members can notify other members in the computing group of the identity of the spam. The other members, upon receipt of the identified spam, individually can choose to ignore the e-mail message, thus capitalizing on the shared spam knowledge. Otherwise the other members can individually choose to ignore the spam determination. In either case, the collective spam knowledge of the computing group can be shared to more accurately identify spam among legitimate e-mail.

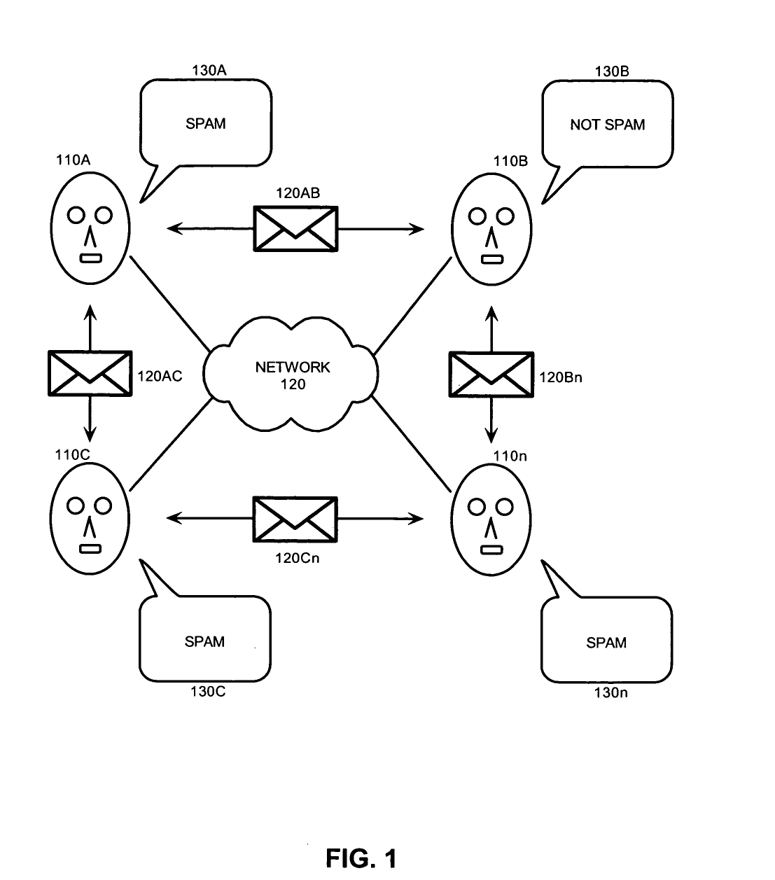

FIG. 1 is a schematic illustration of a system, method and apparatus for cooperative spam processing in accordance with the inventive arrangements. As shown in FIG. 1, peer participants 110A, 110B, 110C, 110n can be coupled together over a computer communications network 120 so that each of the peer participants 110A, 110B, 110C, 110n can provide notifications 120AB, 120AC, 120Bn, 120Cn to one another. Notably, the peer participants 1110A, 1110B, 110C, 110n can cooperate in the identification of spam received by any one of the peer participants 110A, 110B, 110C, 110n.

In a preferred aspect of the invention, when one of the peer participants 110A, 110B, 110C, 110n receives an e-mail, the recipient can apply a determination 130A, 130B, 130C, 130n to the e-mail to determine whether or not the e-mail is spam. If the determination 130A, 130B, 130C, 130n of the recipient is that the e-mail is spam, the other ones of the peer participants 110A, 110B, 110C, 110n can be so notified. The other peer participants 110A, 110B, 110C, 110n can store the identity of the e-mail or its source such that if the e-mail or an e-mail from the source is received in the other peer participants 110A, 110B, 110C, 110n, the e-mail can be treated as spam without requiring intervention by the other peer participants 110A, 110B, 110C, 110n.

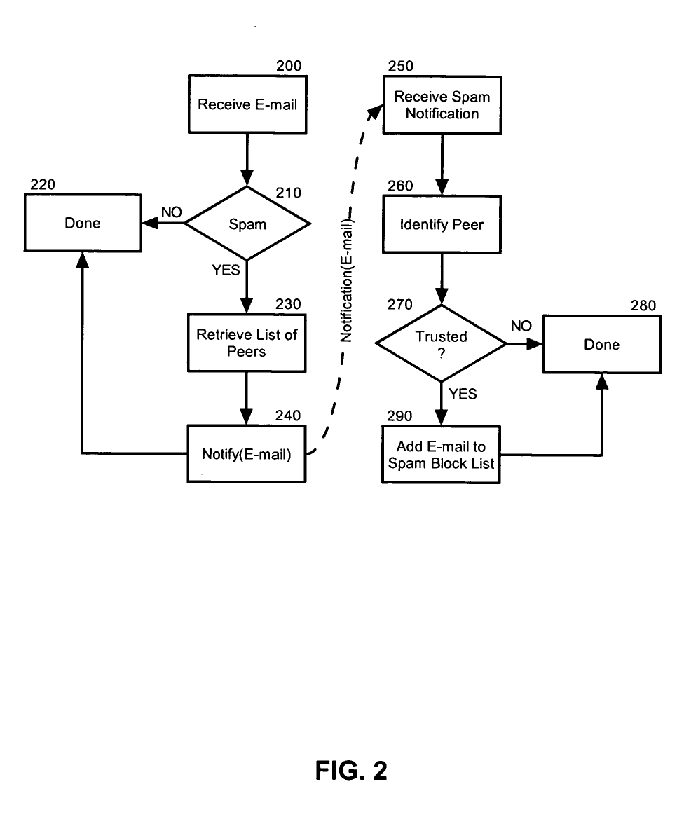

FIG. 2 is a flow chart illustrating a method for cooperative spam processing in the system of FIG. 1. Beginning in block 200, an e-mail can be received. In decision block 210, it can be determined whether the received e-mail is spam. If it is determined that the e-mail is not spam, in block 220 the process can end. Otherwise, in block 230 a list of peers within a common computing group can be retrieved. Subsequently, in block 240 each of the peers in the common computing group can be notified of the received spam. For instance, the notification can include an identity of the e-mail message, or an identity of the source of the e-mail message.

In block 250, the spam notification can be received by the peers in the common computing group. For each peer in the common computing group, in block 260 the sending peer can be identified. Notably, based upon the identity of the sending peer, the spam advice can be heeded or ignored. In this regard, the skilled artisan will recognize that spam means different things to different people. One man's trash is another's treasure. Accordingly, for each peer in the computing group, a policy can be defined which specifies a level of trust for one or more other peers in the computing group. The policy can indicate from the perspective of the peer whether the peer ought to heed the spam advise of the other peers listed in the policy.

To that end, in decision block 270, it can be determined whether the sending peer is a trusted source of spam advise. If hot, the advice can be ignored and the process can end in block 280. Otherwise, if the peer is a trusted source of spam advise, the notification can be heeded and in block 290 the subject e-mail can be added to a spam block list. Notably, additional overriding rules can be applied to identified spam such as ignoring a peer spam notification where the e-mail source is known as an acceptable source. In any event, the actual e-mail can be listed so that if the actual e-mail subsequently is received, the e-mail can be processed as spam without requiring intervention. Optionally, all e-mails received from the source of the spam e-mail can be processed as spam without requiring intervention.

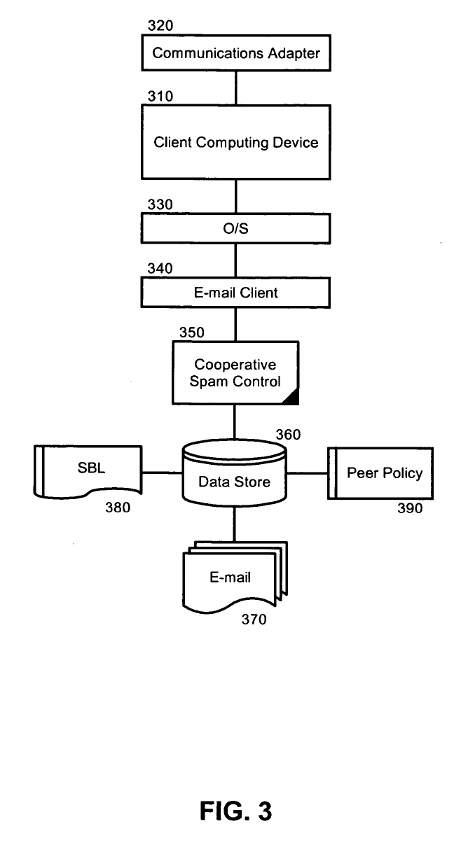

The methodology of the present invention can be practiced in a distributed manner within client side computing devices, in a central manner within a mail server, or both. As one example, FIG. 3 is a block diagram depicting a client-side implementation of the method of FIG. 2. The client-side implementation can include a client computing device 310 configured to receive and process e-mail messages 370 through a communications adapter 320, such as a modem or network interface card. The client computing device 310 further can include a data store 360 in which the e-mail messages 370 can be stored in addition to other data.

The client computing device 310 can include an operating system 330 hosting an e-mail client application 340. E-mail client applications are well-known in the art and the present invention is not limited to any particular e-mail client application implementation. The e-mail client application 340 can include logic for blocking spam associated with information in a spam blocking list 380. The information can include the identity of a particular e-mail message, or the source of an e-mail message. As e-mail messages 370 are received and processed in the e-mail client application 340, the spam blocking list 380 can be consulted to determine whether the e-mail is to be treated as spam. Where an e-mail message has been identified as spam, the e-mail client application 340 can delete the e-mail message, move the e-mail message to a specific message folder, or the e-mail client application 340 can take other remedial measures.

In accordance with the present invention, a cooperative spam control processor 350 can be coupled to the e-mail client application 340. The cooperative spam control processor 350 can be programmed to analyze received e-mail messages 370 so as to identify spam. Notably, the cooperative spam control process 350 can rely wholly on the spam blocking features of the e-mail client application 340, or the cooperative spam control process 350 can supplement the spam blocking features of the e-mail client application 340 with additional spam identification logic. In any case, the cooperative spam control process 350 also can include programming for notifying peers in a common computing group when spam is received in the e-mail client application 340.

Advantageously, a peer policy 390 can be accessed by the cooperative spam control process 350. The peer policy 390 can include data which specifies to what level the cooperative spam control process 350 is to consider the spam identification advice of other peers in the computing group. The peer policy 390 also can include rules for overriding the determination of other peers in the group. Based upon the peer policy 390, when a notification is received from a peer in the computing group, the notification can be used to augment the spam blocking list 380. Alternatively, the notification can be ignored.

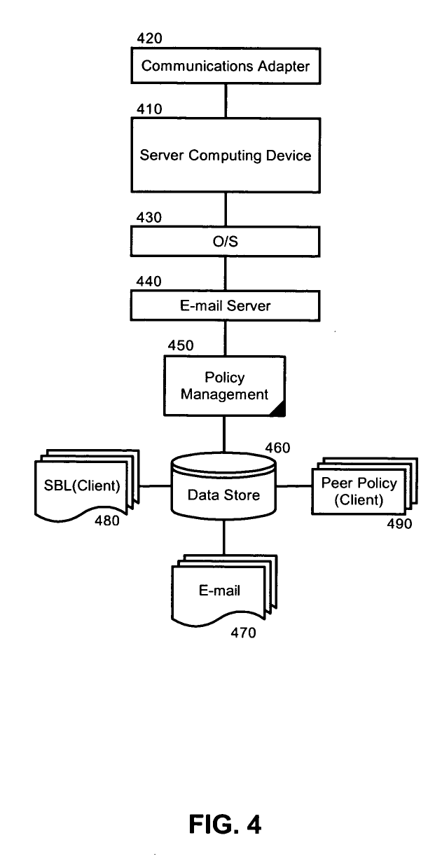

Turning now to FIG. 4, a server-side implementation of the method of FIG. 2 is shown. The server-side implementation can include a server computing device 410 configured to receive and process e-mail messages 470 through a communications adapter 420 in behalf of one or more e-mail clients. The server computing device 410 further an include a data store 460 in which the e-mail messages 470 can be stored in addition to other data. The server computing device 410 can include an operating system 430 hosting an e-mail server application 440. E-mail server applications are well-known in the art and the present invention is not limited to any particular e-mail server application implementation.

The e-mail server application 440 can include logic for blocking spam associated with information in a spam blocking list 480. The information can include the identity of a particular e-mail message, or the source of an e-mail message. As e-mail messages 470 are received and processed in the e-mail server application 440, the spam blocking list 480 can be consulted to determine whether a received e-mail is to be treated as spam, either globally, or on a subscriber-by-subscriber basis. Where an e-mail message has been identified as spam, the e-mail server application 440 can delete the e-mail message, move the e-mail message to a specific message folder, or the e-mail server application 440 can take other remedial measures. Optionally, the function of processing an e-mail message as spam can be left to the e-mail client which can consult the spam blocking list 480 in the server computing device 410.

In accordance with the present invention, a policy management process 450 can be coupled to the e-mail server application 440. The policy management process 450 can be programmed to manage a peer policy 490. The peer policy 490, a centralized version of the peer policy 390 of FIG. 3, can include data which specifies to what level peer subscribers to the cooperative spam control system are to consider the spam identification advice of other peers in the computing group. The peer policy 490 also can include rules for overriding the determination of other peers in the group. Finally, the peer policy 490 can limit access to the spam blocking list 480 on a peer by peer basis. While some peers are accorded the right both to notify other peers of spam, and to receive spam notifications, others can be limited to one or the other.

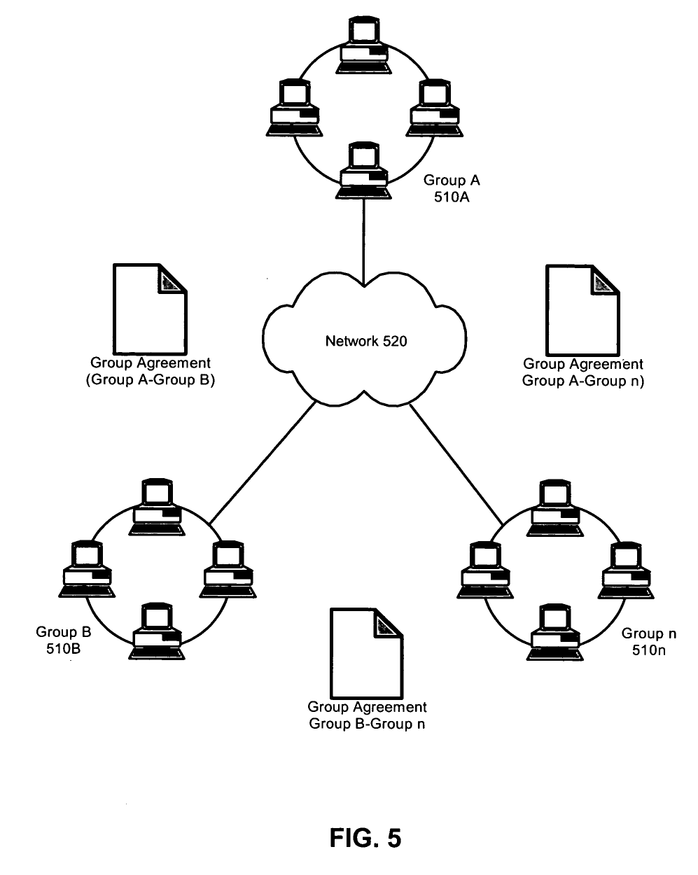

A trusted computing group of e-mail peers can be defined within the present invention as a group of participants who trust each other with regard to the identification of spam. Typical groups can include business teams, family members, religious organizations, clubs and the like. Each group can nominate a trusted group administrator who can authorize and control membership to the group. Importantly, different groups can agree to share spam information much as individual peers in a single group can share spam information. In this regard, FIG. 5 is a pictorial illustration of a system and method for inter-group cooperative spam processing in accordance with a particular embodiment of the present invention.

As shown in FIG. 5; two or more computing groups 510A, 510B, 510n can be coupled to one another communicatively over the computer communications network 520. Each of the computing groups 510A, 510B, 510n can include a cooperative spam processing system in which the individual members of the computing groups 510A, 510B, 510n can report suspected spam within their respective computing groups 510A, 510B, 510n. Similarly, each one of the individual members of the computing groups 510A, 510B, 510n can receive spam notifications from their peers within their respective computing groups 510A, 510B, 510n.

Each one of the computing groups 510A, 510B, 510n can engage in a group agreement with each other of the computing groups 510A, 510B, 510n. The group agreement can provide a foundation for exchanging spam notifications between groups. A policy can be established in each of the computing groups 510A, 510B, 510n which determines which level of trust should be applied to spam notifications emanating for other ones of the computing groups 510A, 510B, 510n. Initially, the spam notifications can be un-trusted, for example, while at a later time, once trust has been established in the judgment of the members of the other computing groups 510A, 510B, 510n, the spam notifications can be treated at the same level as those notifications emanating from within the respective computing groups 510A, 510B, 510n.

In this way, ultimately, the computing groups 510A, 510B, 510n can merge in their cooperative spam processing efforts. Alternatively, the computing groups 510A, 510B, 510n can remain separate with periodic re-certification intervals occurring to periodically test the level of trust between the computing groups 510A, 510B, 510n. Notably, to streamline the establishment of the group agreements, a group administrator can be appointed for each of the computing groups 510A, 510B, 510n. Each group administrator can be empowered to negotiate cooperative spam processing with the group administrators of others of the computing groups 510A, 510B, 510n.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A cooperative spam processing system comprising:
a plurality of e-mail clients communicatively linked to one another; and,
a plurality of cooperative spam control processors, each of said processor coupled to a corresponding one of said e-mail clients, wherein said cooperative spam control processors comprises programming for detecting spam and for notifying others of said cooperative spam control processors of said spam.

2. The system of claim 1, further comprising a plurality of peer policies, each of said policies coupled to a corresponding one of said spam control processors.

3. The system of claim 1, further comprising a centrally managed peer policy coupled to a mail server associated with each of said e-mail clients and communicatively linked to said spam control processors.

4. The system of claim 1, further comprising a group administrator for said e-mail clients, said group administrator having authority to establish an agreement to exchange spam notifications with other groups of e-mail clients having respective cooperative spam control processors.

5. A cooperative spam control method comprising the steps of:
accepting an electronic spam notification received from a peer e-mail recipient in a common computing group identifying a spam message received by said peer e-mail recipient;
storing said notification; and,
if an e-mail is subsequently received which corresponds to said identified spam message, processing said received e-mail as spam.

6. The method of claim 5, further comprising the steps of:
determining that a received e-mail is spam; and,
communicating an electronic spam notification identifying said received e-mail determined to be spam to other peer e-mail recipients in said common computing group.

7. The method of claim 5, wherein said processing step comprises the steps of:
consulting a peer policy for said peer e-mail recipient comprising rules for handling e-mail identified as spam by said peer e-mail recipient;
heeding said notification if said rules indicate that notifications from said peer e-mail recipient are to be heeded; and,
ignoring said notification if said rules indicate that notifications from said peer e-mail recipient are to be ignored.

8. The method of claim 7, further comprising the step of overriding said notification where said e-mail message meets criteria established in said policy for overriding a spam notification.

9. The method of claim 7, wherein said consulting step comprises the step of consulting an internally managed local peer policy.

10. The method of claim 7, wherein said consulting step comprises the step of consulting a centrally managed remote peer policy.

11. The method of claim 6, further comprising the steps of:
establishing an agreement with a different computing group for exchanging spam notifications;
forwarding spam notifications from individual peer e-mail recipients in said common computing group to said different computing group;
receiving spam notifications from said different computing group; and,
storing said received spam notifications in individual peer e-mail recipients in said common computing group.

12. A machine readable storage having stored thereon a computer program for cooperative spam control, the computer program comprising a routine set of instructions which when executed by a machine cause the machine to perform the steps of:
accepting an electronic spam notification received from a peer e-mail recipient in a common computing group identifying a spam message received by said peer e-mail recipient;
storing said notification; and,
if an e-mail is subsequently received which corresponds to said identified spam message, processing said received e-mail as spam.

13. The machine readable storage of claim 12, further comprising the steps of:
determining that a received e-mail is spam; and,
communicating an electronic spam notification identifying said received e-mail determined to be spam to other peer e-mail recipients in said common computing group.

14. The machine readable storage of claim 12, wherein said processing step comprises the steps of:
consulting a peer policy for said peer e-mail recipient comprising rules for handling e-mail identified as spam by said peer e-mail recipient;
heeding said notification if said rules indicate that notifications from said peer e-mail recipient are to be heeded; and,
ignoring said notification if said rules indicate that notifications from said peer e-mail recipient are to be ignored.

15. The machine readable storage of claim 14, further comprising the step of overriding said notification where said e-mail message meets criteria established in said policy for overriding a spam notification.

16. The machine readable storage of claim 14, wherein said consulting step comprises the step of consulting an internally managed local peer policy.

17. The machine readable storage of claim 14, wherein said consulting step comprises the step of consulting a centrally managed remote peer policy.

18. The machine readable storage of claim 13, further comprising the steps of:
establishing an agreement with a different computing group for exchanging spam notifications;
forwarding spam notifications from individual peer e-mail recipients in said common computing group to said different computing group;
receiving spam notifications from said different computing group; and,
storing said received spam notifications in individual peer e-mail recipients in said common computing group.
